(19) United States
(12) Patent Application Publication
(10) Pub. No.: US 2023/0349594 A1
(43) Pub. Date: Nov. 2, 2023

(54) STAND FOR SUPPORTING A HELIOSTAT

(71) Applicant: Heliogen Holdings, Inc., Pasadena, CA (US)

(72) Inventors: Steven Edward Schell, Arcadia, CA (US); Kyam Krieger, Los Angeles, CA (US); Caroline Lee Paules, Pasadena, CA (US)

(21) Appl. No.: 18/295,395

(22) Filed: Apr. 4, 2023

Related U.S. Application Data
(60) Provisional application No. 63/363,692, filed on Apr. 27, 2022.

(51) Int. Cl. F24S 25/13

(52) U.S. Cl. CPC F24S 25/13

(57) ABSTRACT

A lightweight and rigid stand for supporting a heliostat includes multiple legs that extend between a lower end and upper end. A bracket or knuckle couples to an upper end of the legs and can support a heliostat thereon so that the bracket or knuckle is disposed between the upper end of the legs and the heliostat. A dimensional spacing or angular orientation between the legs is maintained by the backet or knuckle and/or bridge portions that extend between linear portions of the legs. Lower ends of the legs can be embedded in a ballast mass.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The invention generally pertains to a heliostat device for capturing solar energy. In particular, the invention relates to a stand for supporting a heliostat.

### SUMMARY

In accordance with one aspect of the disclosure, a stand for supporting a heliostat is provided. The stand comprises three legs, each of the legs extending linearly from an upper end to a lower end. The legs are configured to extend at an angle relative to each other so that the upper ends of the legs are closer to each other than the lower ends of the legs. The upper ends are configured to couple to a knuckle or bracket for supporting a heliostat thereon, and the lower ends of the legs are configured to attach to a ballast mass.

In accordance with one aspect of the disclosure, a stand for supporting a heliostat is provided. The stand comprises a pair of legs, each of the pair of legs being a mirror image of the other of the pair of legs. Each leg of the pair of legs comprises a first linear portion, a second linear portion and a bridge portion that extends between and connects the first linear portion and the second linear portion. The second linear portion extends at an angle relative to the first linear portion so that upper ends of the first and second linear portions are closer to each other than lower ends of the first and second linear portion. The bridge portion extends between and connects the lower ends of the first and second linear portions and defines a lower end of each leg. The bridge portion is configured to attach to a ballast mass.

In accordance with another aspect of the disclosure, a stand for supporting a heliostat is provided. The stand comprises a pair of legs, each of the pair of legs being a mirror image of the other of the pair of legs. Each leg comprises a first linear portion, a second linear portion that extends at an angle relative to the first linear portion, and a bridge portion that extends between and connects an upper end of the first linear portion and an upper end of the second linear portion and defines an upper end of each of the pair of legs.

### BRIEF DESCRIPTION OF THE DRAWINGS

FIG. 1 is a schematic perspective view of a heliostat assembly.

FIG. 2 is a schematic perspective view of a stand of the heliostat assembly in FIG. 1.

FIG. 3 is a schematic perspective view of the stand of FIG. 2 without the concrete ballast.

FIG. 4 is a schematic view of an upper portion of the stand of FIG. 2 showing a clamp assembly.

FIG. 5 is a schematic view of a lower portion of the stand of FIG. 2.

FIG. 6 is a side view of a leg of the stand of FIG. 2.

FIG. 7 is a front view of the legs of the stand of FIG. 2.

FIG. 8 is a top view of the legs of the stand of FIG. 2.

FIG. 9 is a schematic view of a lower portion of a leg of the stand of FIG. 2.

FIG. 10 is a schematic view of a stand for use with a heliostat assembly.

FIG. 11 is a schematic view of a stand for use with a heliostat assembly.

FIG. 12 is a schematic view of a stand for use with a heliostat assembly.

### DETAILED DESCRIPTION

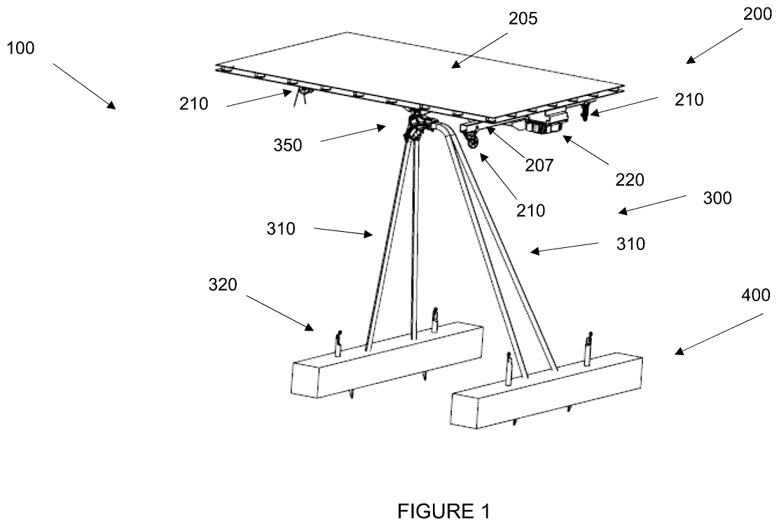

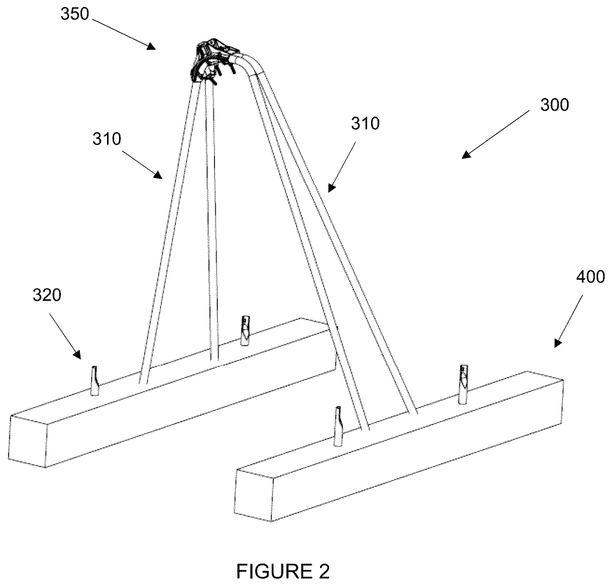

FIG. 1 shows a heliostat 100, which includes a heliostat mirror assembly 200, a stand assembly 300 that supports the heliostat mirror assembly 200. At least a portion of the stand assembly 300 can attach to (e.g., be embedded in) a ballast mass 400. In one implementation, the ballast mass 400 can be concrete or cement that is poured into a trench (not shown) into which a bottom portion of the stand assembly 300 is inserted prior to pouring the concrete or cement into the trench and over the bottom portion of the stand assembly 300. In the illustrated implementation, the top surface of the ballast mass 400 is flush with grade. The heliostat mirror assembly 200 includes a mirror 205, a frame 207 that supports the mirror 205, a plurality of pulleys 210 and a drive mechanism 220 (e.g., one or more electric motors). The stand assembly 300 includes a pair of legs 310, each being a mirror image of the other. A clamp 350 couples to the pair of legs 310, as further discussed below. The clamp 350 couples to and supports the heliostat mirror assembly 200. Each of the pair of legs 310 has a pair of upright members 320 that protrude from the ballast mass 400 when the stand assembly 300 is attached to the ballast mass 400. Though not shown, cables can have one end coupled (e.g., fixed) to the ends 322 of the upright members 320, extend at least partially around one or more of the pulleys 210 and couple to the drive mechanism 220. The drive mechanism 220 can selectively move one or more of the cables to change an orientation of the heliostat mirror assembly 200 (e.g., in pitch or roll) relative to the stand assembly 300. FIG. 2 shows the heliostat mirror assembly 200 decoupled from the clamp 350.

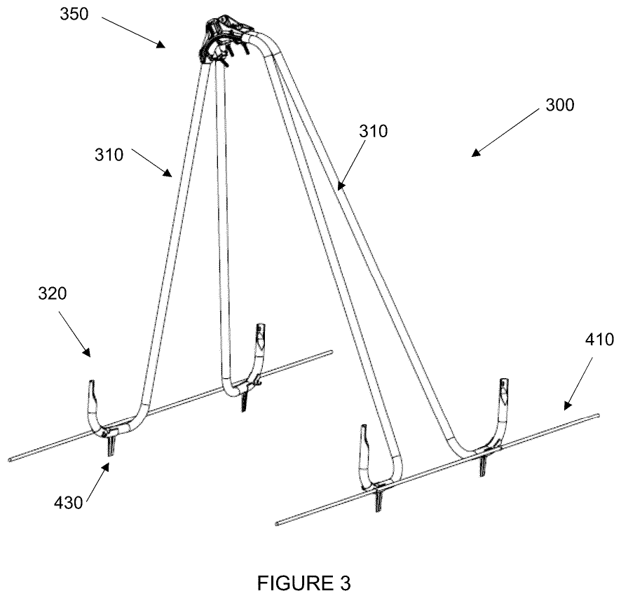

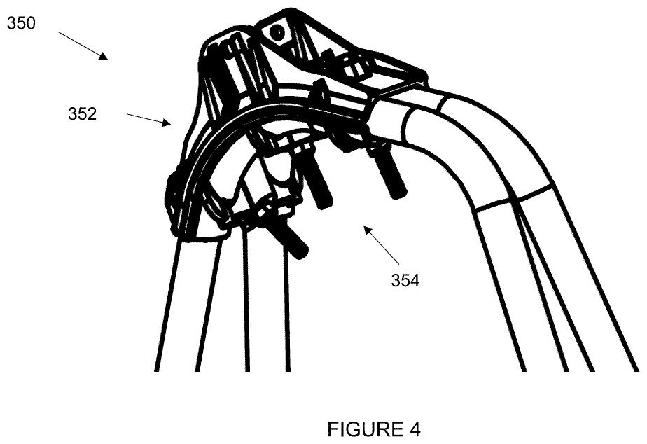

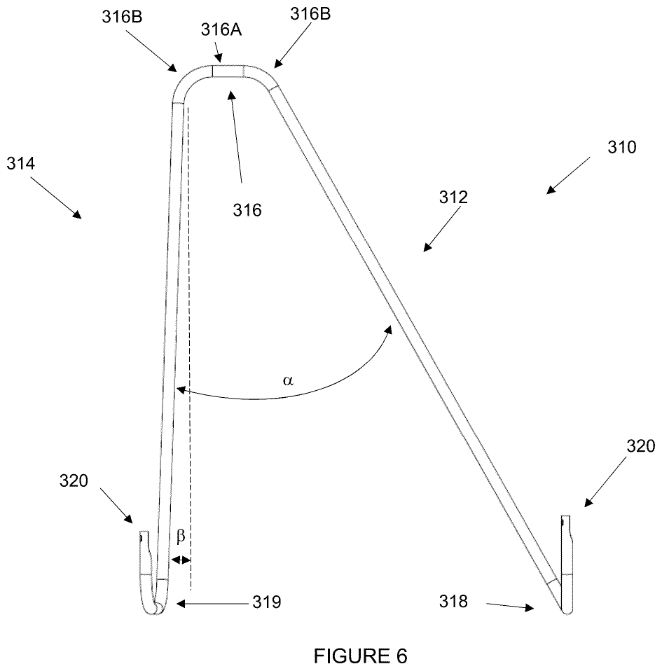

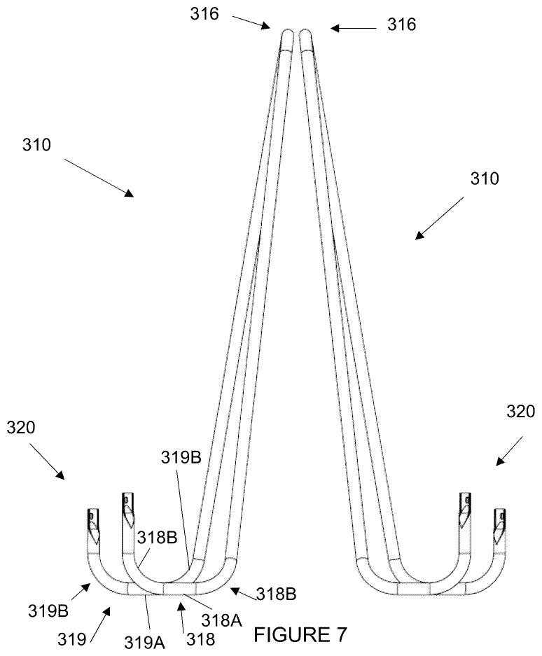

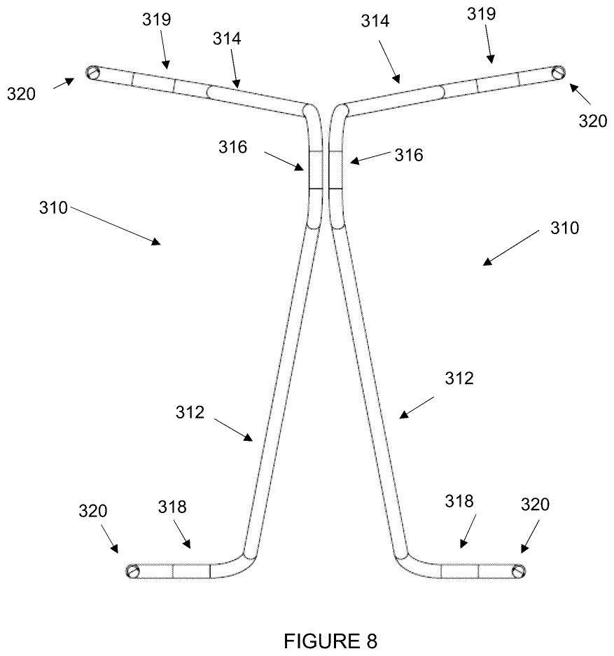

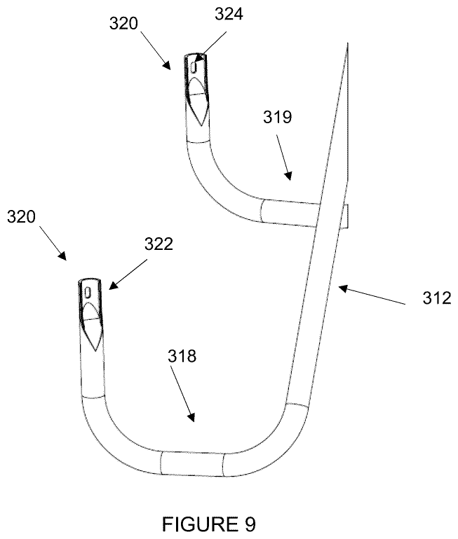

FIGS. 3-9 show features of the stand assembly 300 without the ballast mass 400. Each of the pair of legs 310 is a mirror image of the other. In one implementation, the legs 310 can be made of coated carbon steel or galvanized steel. In one implementation, each leg 310 is a single piece (e.g., a continuous monolithic or seamless piece). In another implementation, each leg 310 can be an assembly of separate tube portions that when assembled together (e.g., sliding an end of one tube portion over an end of another tube portion) form the leg 310. In one implementation, each leg 310 is formed by bending a tube (e.g., a single or monolithic and seamless hollow tube) to define the various portions of the leg 310, advantageously simplifying the manufacture of the stand assembly 300. In one implementation, the leg 310 can be formed by a tube having a circular cross-section (e.g., a circular annular cross-section). Each of the legs 310 has a first linear portion 312, a second linear portion 314 that extends at an angle α relative to the first linear portion 312, and a bridge portion 316 that extends between and connects an upper end of the first linear portion 312 and an upper end of the second linear portion 314. The angle α can be an acute angle. The second linear portion 314 extends at an angle β relative to vertical (e.g., an acute angle) that advantageously facilitate the clearance needed to have the heliostat mirror assembly 200 operate over a desired range of pitch and roll motion. The bridge portion 316 can have a linear or horizontal portion 316A extending between two curved portions 316B, the two curved portions 316B connecting the linear portion 316A to the upper ends of the first linear portion 312 and the second linear portion 314. The stand assembly 300 can be lightweight (e.g., due at least in part to the hollow tube being used). The bridge portion 316 can advantageously help maintain dimensional spacing (e.g., lateral spacing) between the first linear portion 312 and the second linear portion 314.

Each leg 310 includes a first foot portion 318 that connects to a lower end of the first linear portion 312 and a second foot portion 319 that connects to a lower end of the second linear portion 314. The first foot portion 318 includes a linear portion 318A and a pair of curved portions 318B that connect the linear portion 318A to the lower end of the first linear portion 312 and to its associated upright member 320. The second foot portion 319 includes a linear portion 319A and a pair of curved portions 319B that connect the linear portion 319A to the lower end of the second linear portion 314 and to its associated upright member 320. Each of the upright members 320 can have an end 322 that is crimped or compressed (e.g., one side of the tube portion compressed and deformed to contact the opposite side of the tube portion) to maintain a stiff structure as well as semi-close the ends 322 to inhibit (e.g., prevent) water ingress (e.g., due to rain) via the ends 322. The end 322 can have an opening 324 (e.g., anchor point) via which an end of the cable (not shown) can be coupled to the upright member 320.

The clamp 350 can have an upper clamp portion 352 that extends over the bridge portion 316 of the pair of legs 310 (e.g., the upper clamp portion 352 spans across the bridge portion 316 of both legs 310). A lower clamp portion 354 that extends under the bridge portion 316 of the pair of legs 310 (e.g., the lower clamp portion 354 spans across the bridge portion 316 of both legs 310). The upper clamp portion 352 can couple to the lower clamp portion 354 (e.g., with one or more bolts, three bolts). Advantageously, the clamp 350 extends over the linear portion 316A and one of the two curved portions 316B (e.g., the one proximate the second linear portion 314) of each of the legs 310, which inhibits (e.g., prevents) the clamp 350 from shifting (e.g., sliding, moving, rotating about the curved outer surface of the tube of the leg 310) relative to the pair of legs 310 and increases the rigidity or stiffness of the stand assembly 300. The clamp 350 can be cast aluminum. In another implementation, the clamp 350 can be made of sheet metal.

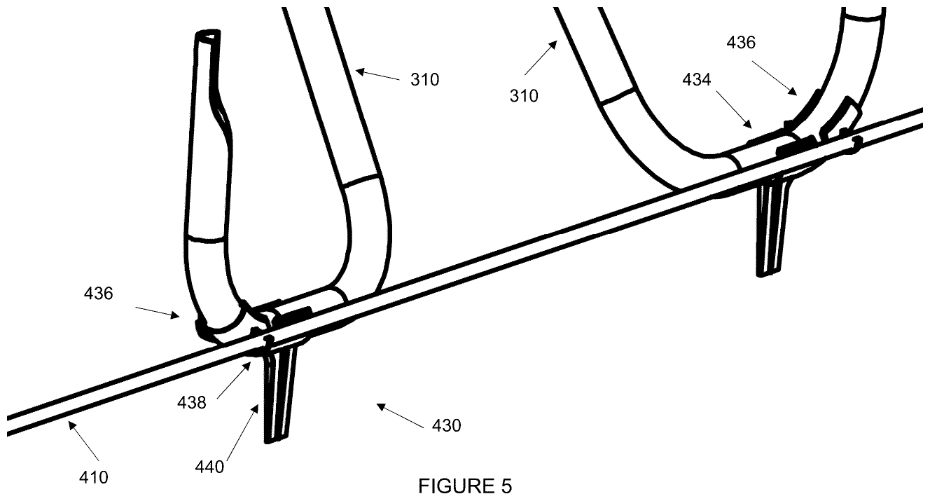

With reference to FIG. 5, each of the first foot portion 318 and the second foot portion 319 of each leg 310 has a bracket 430 attached to it (e.g., that snaps to the first foot portion 318 and the second foot portion 319). The bracket 430 includes a spike 440 that extends below the first foot portion 318 and the second foot portion 319. The bracket 430 also has a first bracket portion 434 coupleable to the linear portion 318A, 319A of the first foot portion 318 and the second foot portion 319, and the bracket 430 has a second portion 436 coupleable to the curved portion 318B that extends between the linear portion 318A, 319A and the upright members 320. By coupling to the linear portion 318A, 319A and the curved portions 318B, 319B, the bracket 430 advantageously inhibits (e.g., prevents) the bracket 430 from shifting (e.g., sliding, moving, rotating about the curved outer surface of the tube of the leg 310) relative to the first foot portion 318 and the second foot portion 319. The bracket 430 also includes a hook 438 attached to the second portion 436 sized to receive and support a linear rod 410 (e.g., a rebar rod), where the linear rod 410 can provide additional structural rigidity to the ballast mass 400 (e.g., concrete, cement) is attached to the stand assembly 300 (e.g., by pouring cement or concrete in a trench opening into which the first foot portion 318 and second foot portion 319 with the brackets 430 has been inserted). The bracket 430 can be made of injection molded plastic. In another implementation, the bracket 430 can be made of sheet metal.

The spike 440 of the bracket 430 facilitates location of the first foot portion 318 and the second foot portion 319 for each of the legs 310 in the trench (e.g., ditch standoff), for example, so that they are located at the same elevation and so that the upright members 320 protrude by the same amount from the ballast mass 400 and the bridge portion 316 of the pair of legs 310 are level (e.g., so the linear portion 316A of the bridge portion 316 is substantially horizontal). Additionally, the bracket 430 attached to the first foot portion 318 and the second foot portion 319 of each of the pair of legs 310 advantageously helps maintain dimensional spacing (e.g., lateral spacing) between the first foot portions 318 of the two legs 310, and between the second foot portion 319 of the two legs 310. The linear rod 410 (e.g., ridges of the rebar rod), when coupled to the brackets 430 via the hooks 438, maintains the spacing between the first foot portions 318 of the two legs 310, and between the second foot portion 319 of the two legs 310.

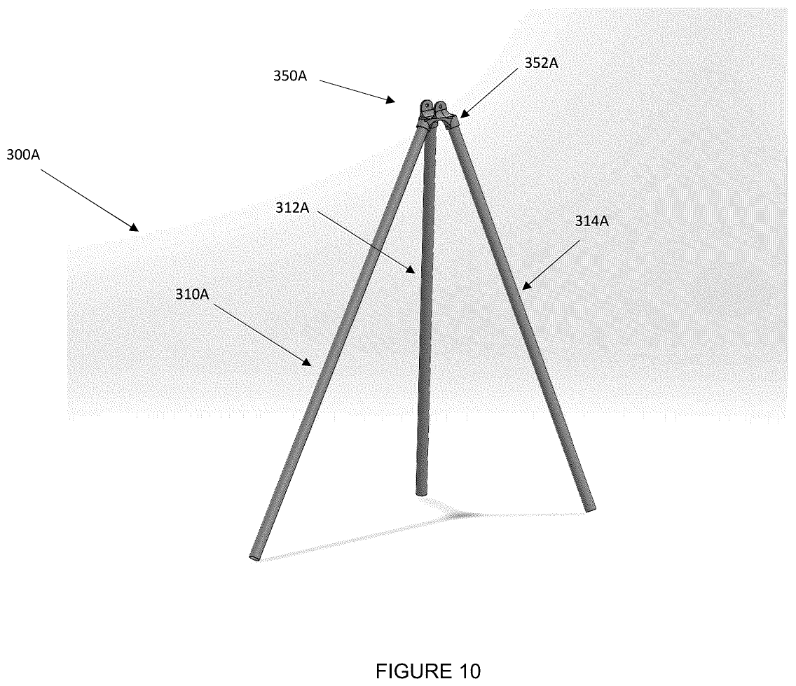

FIG. 10 shows another embodiment of a stand assembly 300A. The stand assembly 300A can have three legs 310A, 312A, 314A (e.g., three separate and independent legs). However, in other implementations, the stand assembly can have four legs. Each of the legs 310A, 312A, 314A can in one embodiment be a linear tube (e.g., a hollow linear tube) and have a circular cross-section, which advantageously facilitates (e.g., makes easier) the manufacturing of, and reduces the manufacturing cost and time of, the stand assembly 300A. However, the legs 310A, 312A, 314A can have other suitable cross-sections. A bracket or knuckle 350A can attach to the top end of the legs 310A, 312A, 314A. A heliostat mirror assembly, such as the heliostat mirror assembly 200 in FIG. 1, can be coupled to the bracket or knuckle 350A. Advantageously, the bracket or knuckle 350A couples to the top end of the legs 310A, 312A, 314A (e.g., via caps 352A of the bracket or knuckle 350A that fit over the ends of the legs 310A, 312A, 314A) so as to maintain a specific spacing (e.g., angular orientation) between the legs 310A, 312A, 314A. In one implementation, the backet or knuckle 350A and the caps 352A are a single (e.g., monolithic, seamless) piece. Though not shown, in one implementation, the legs 310A, 312A, 314A (e.g., bottom end of the legs 310A, 312A, 314A) can optionally be attached to (e.g., be embedded in) a ballast mass, such as concrete or cement poured into a trench (not shown). Though not shown, in one embodiment, a ditch standoff bracket with a spike (similar to the spike 440) can optionally be attached to the bottom ends of the legs 310A, 312A, 314A.

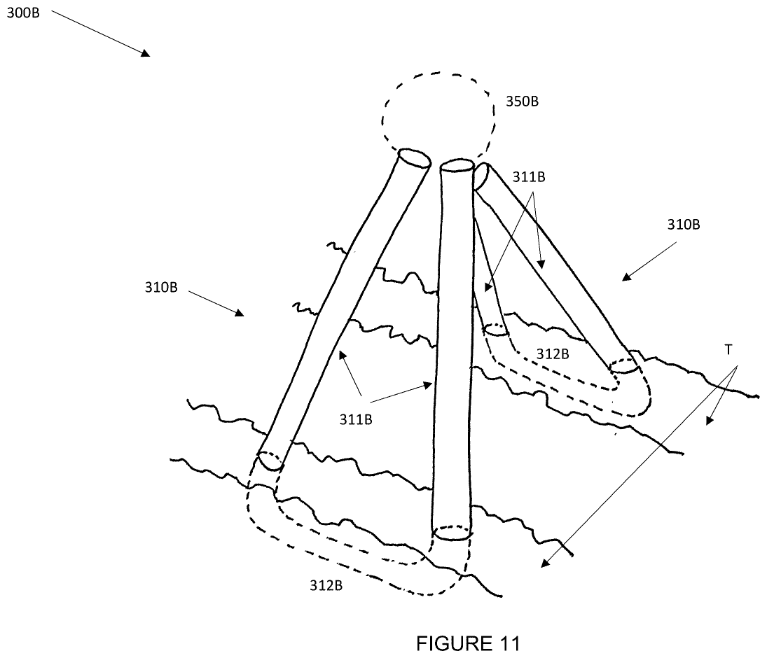

FIG. 11 shows another embodiment of a stand assembly 300B. The stand assembly 300B can have two legs 310B (e.g., two separate and independent legs). Each of the legs 310B has two linear portions 311B that can extend to free upper ends, and a horizontal portion 312B (e.g., bridge portion) that interconnects the bottom of the two linear portions 311B. Each of the legs 310B can be formed by ending a linear tube at two locations to form the angles between the linear portions 311B and the horizontal portion 312B. In one embodiment, the legs 310B can be a hollow tube with a circular cross-section. The horizontal portion 312B (e.g., bridge portion) can advantageously help maintain dimensional spacing (e.g., lateral spacing) between the linear portions 311B of the legs 310B. A bracket or knuckle (not shown) can attach to the top end of the legs 310B. A heliostat mirror assembly, such as the heliostat mirror assembly 200 in FIG. 1, can be coupled to the bracket or knuckle 350B. Advantageously, the bracket or knuckle 350B couples to the top end of the legs 310B (e.g., via cap portions similar to the caps 352A of the knuckle or bracket 350A that fit over the ends of the linear portions 311B) so as to maintain a specific spacing (e.g., angular orientation) between the legs 310B. The legs 310B (e.g., the horizontal portion 312B of each leg 310B) can optionally be attached to (e.g., be embedded in) a ballast mass, such as concrete or cement poured into a trench T. Though not shown, in one embodiment, a ditch standoff bracket with a spike (similar to the spike 440) can optionally be attached to the horizontal portion 312B of each of the legs 310B (e.g., near the junction between the horizontal portion 312B and the linear portions 311B).

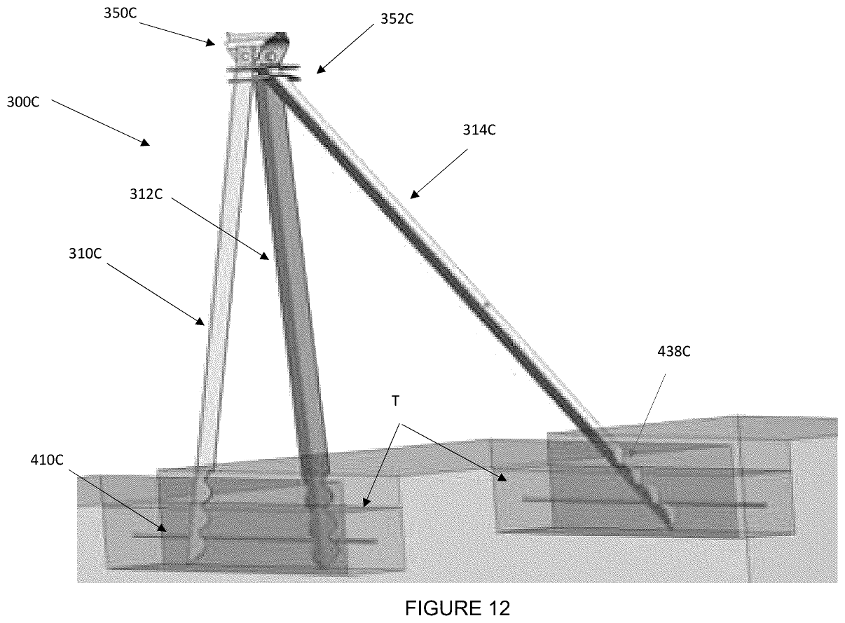

FIG. 12 shows another embodiment of a stand assembly 300C. Some of the features of the stand assembly 300C are similar to features of the stand assembly 300A in FIG. 10. Thus, reference numerals used to designate the various components of the stand assembly 300C are identical to those used for identifying the corresponding components of the stand assembly 300A in FIG. 10, except that a “C” instead of an “A” has been added to the numerical identifier. Therefore, the structure and description for the various features of the stand assembly 300A and how it's operated in FIG. 10 are understood to also apply to the corresponding features of the stand assembly 300C in FIG. 12, except as described below.

The stand assembly 300C can have three legs 310C, 312C, 314C (e.g., three separate and independent legs). However, in other implementations, the stand assembly can have four legs. Each of the legs 310C, 312C, 314C can in one embodiment be a linear member and have an L or V shaped cross-section, which advantageously facilitates (e.g., makes easier) the manufacturing of, and reduces the manufacturing cost and time of, the stand assembly 300C. However, the legs 310C, 312C, 314C can have other suitable cross-sections. A bracket or knuckle 350C can attach to the top end of the legs 310C, 312C, 314C. A heliostat mirror assembly, such as the heliostat mirror assembly 200 in FIG. 1, can be coupled to the knuckle or bracket 350C. Advantageously, the knuckle or bracket 350C couples to the top end of the legs 310C, 312C, 314C (e.g., via fasteners, such as bolts). Also, one or more support members (e.g., rings) 352C can fit over the ends of the legs 310C, 312C, 314A, 310B, 314C so as to maintain a specific spacing (e.g., angular orientation) between the legs 310C, 312C, 314C. Each of the legs 310C, 312C, 314C can have one or more recesses, slots or cutouts 438C (e.g., serrated portion) on the bottom ends thereof. The recess(es), slot(s) or cutout(s) can receive and support a linear rod 410C (e.g., a rebar rod), where the linear rod 410C can advantageously provide additional structural rigidity to a ballast mass (e.g., concrete, cement) that is attached to the stand assembly 300C (e.g., by pouring cement or concrete in a trench opening T into which the portion of the legs 310C, 312C, 314C with the recesses, slots or cutouts 438C).

### Additional Embodiments

In embodiments of the present disclosure, a stand for supporting a heliostat may be in accordance with any of the following clauses:

Clause 1: A stand for supporting a heliostat, comprising:
three legs, each of the legs extending linearly from an upper end to a lower end, the legs configured to extend at an angle relative to each other so that the upper ends of the legs are closer to each other than the lower ends of the legs, the upper ends configured to couple to a knuckle or bracket for supporting a heliostat thereon, the lower ends of the legs configured to attach to a ballast mass.

Clause 2: The stand of clause 1, wherein the lower end of each of the legs has one or more cutouts or recesses configured to receive and support a rod that extends generally transverse to the leg.

Clause 3: The stand of clause 2, wherein the one or more cutouts or recesses define a serrated portion in the lower end of each of the legs.

Clause 4: The stand of any preceding clause, wherein the three legs are connected by one or more cap portions that extend over the upper ends of the three legs.

Clause 5: The stand of any preceding clause, wherein each of the legs is a hollow tube with a circular cross-section.

Clause 6: The stand of any of clauses 1-5, wherein each of the legs is a rod with an L shaped or V shaped cross-section.

Clause 7: The stand of any preceding clause, further comprising the knuckle or bracket attached to the upper ends of the legs the knuckle or bracket configured to couple to and support the heliostat thereon.

Clause 8: The stand of clause 7, wherein the knuckle or bracket attaches to the upper ends of the legs via three caps, each cap configured to fit over an upper end of one of the legs.

Clause 9: The stand of any preceding clause 1, further comprising one or more support rings configured to fit over the upper ends of the legs to maintain a spacing and angular orientation between the legs.

Clause 10: A stand for supporting a heliostat, comprising:
a pair of legs, each of the pair of legs being a mirror image of the other of the pair of legs, each leg of the pair of legs comprising
a first linear portion,
a second linear portion that extends at an angle relative to the first linear portion so that upper ends of the first linear portion and the second linear portion are closer to each other than lower ends of the first linear portion and the second linear portion, and
an bridge portion that extends between and connects the lower ends of the first linear portion and the second linear portion and defines a lower end of the leg, wherein the bridge portion is configured to attach to a ballast mass.

Clause 11: The stand of clause 10, wherein the angle is an acute angle.

Clause 12: The stand of any of clauses 10-11, further comprising a clamp configured to couple to an upper end of each of the pair of legs, the clamp configured to couple to a heliostat mirror assembly and be disposed between the heliostat mirror assembly and the pair of legs.

Clause 13: The stand of any of clauses 10-12, wherein each of the legs is a continuous monolithic hollow tube with a circular cross-section.

Clause 14: A stand for supporting a heliostat, comprising:
a pair of legs, each of the pair of legs being a mirror image of the other of the pair of legs, each of the pair of legs comprising
a first linear portion,
a second linear portion that extends at an angle relative to the first linear portion, and
a bridge portion that extends between and connects an upper end of the first linear portion and an upper end of the second linear portion and defines an upper end of each of the pair of legs.

Clause 15: The stand of clause 14, further comprising:
a first foot portion that extends from a lower end of the first linear portion and includes a horizontal member and an upright member that extends from the horizontal member and terminates at a free end, and
a second foot portion that extends from a lower end of the second linear portion and includes a second horizontal member and a second upright member that extends from the second horizontal member and terminates at a free end.

Clause 16: The stand of any of clauses 14-15, further comprising a bracket coupleable to each of the first foot portion and the second foot portion of the pair of legs, the bracket including a spike configured to extend below the first foot portion and the second foot portion, the bracket having a hook configured to receive and support a rebar rod.

Clause 17: The stand of any of clauses 14-16, wherein the bracket is configured to couple to a linear portion and to a curved portion of each of the first foot portion and the second foot portion of the pair of legs to thereby inhibit movement of the bracket relative to the first foot portion and to the second foot portion.

Clause 18: The stand of any of clauses 14-17, wherein the angle is an acute angle.

Clause 19: The stand of any of clauses 14-18, further comprising a clamp configured to couple to the bridge portion of the pair of legs, the clamp configured to couple to a heliostat mirror assembly and be disposed between the heliostat mirror assembly and the pair of legs.

Clause 20: The stand of clause 19, wherein the clamp is configured to couple to a linear portion and to a curved portion of the bridge portion of the pair of legs to thereby inhibit movement of the clamp relative to the pair of legs.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A stand for supporting a heliostat, comprising:
three legs, each of the legs extending linearly from an upper end to a lower end, the legs configured to extend at an angle relative to each other so that the upper ends of the legs are closer to each other than the lower ends of the legs, the upper ends configured to couple to a knuckle or bracket for supporting a heliostat thereon, the lower ends of the legs configured to attach to a ballast mass.

2. The stand of claim 1, wherein the lower end of each of the legs has one or more cutouts or recesses configured to receive and support a rod that extends generally transverse to the leg.

3. The stand of claim 2, wherein the one or more cutouts or recesses define a serrated portion in the lower end of each of the legs.

4. The stand of claim 1, wherein the three legs are connected by one or more cap portions that extend over the upper ends of the three legs.

5. The stand of claim 1, wherein each of the legs is a hollow tube with a circular cross-section.

6. The stand of claim 1, wherein each of the legs is a rod with an L shaped or V shaped cross-section.

7. The stand of claim 1, further comprising the knuckle or bracket attached to the upper ends of the legs the knuckle or bracket configured to couple to and support the heliostat thereon.

8. The stand of claim 7, wherein the knuckle or bracket attaches to the upper ends of the legs via three caps, each cap configured to fit over an upper end of one of the legs.

9. The stand of claim 1, further comprising one or more support rings configured to fit over the upper ends of the legs to maintain a spacing and angular orientation between the legs.

10. A stand for supporting a heliostat, comprising:
a pair of legs, each of the pair of legs being a mirror image of another of the pair of legs, each leg of the pair of legs comprising:
a first linear portion,
a second linear portion that extends at an angle relative to the first linear portion so that upper ends of the first linear portion and the second linear portion are closer to each other than lower ends of the first linear portion and the second linear portion, and
an bridge portion that extends between and connects the lower ends of the first linear portion and the second linear portion and defines a lower end of the leg, wherein the bridge portion is configured to attach to a ballast mass.

11. The stand of claim 10, wherein the angle is an acute angle.

12. The stand of claim 10, further comprising a clamp configured to couple to an upper end of each of the pair of legs, the clamp configured to couple to a heliostat mirror assembly and be disposed between the heliostat mirror assembly and the pair of legs.

13. The stand of claim 10, wherein each of the legs is a continuous monolithic hollow tube with a circular cross-section.

14. A stand for supporting a heliostat, comprising:
a pair of legs, each of the pair of legs being a mirror image of another of the pair of legs, each of the pair of legs comprising:
a first linear portion,
a second linear portion that extends at an angle relative to the first linear portion, and
a bridge portion that extends between and connects an upper end of the first linear portion and an upper end of the second linear portion and defines an upper end of each of the pair of legs.

15. The stand of claim 14, further comprising:
a first foot portion that extends from a lower end of the first linear portion and includes a horizontal member and an upright member that extends from the horizontal member and terminates at a free end, and
a second foot portion that extends from a lower end of the second linear portion and includes a second horizontal member and a second upright member that extends from the second horizontal member and terminates at a free end.

16. The stand of claim 15, further comprising a bracket coupleable to each of the first foot portion and the second foot portion of the pair of legs, the bracket including a spike configured to extend below the first foot portion and the second foot portion, the bracket having a hook configured to receive and support a rebar rod.

17. The stand of claim 16, wherein the bracket is configured to couple to a linear portion and to a curved portion of each of the first foot portion and the second foot portion of the pair of legs to thereby inhibit movement of the bracket relative to the first foot portion and to the second foot portion.

18. The stand of claim 14, wherein the angle is an acute angle.

19. The stand of claim 14, further comprising a clamp configured to couple to the bridge portion of the pair of legs, the clamp configured to couple to a heliostat mirror assembly and be disposed between the heliostat mirror assembly and the pair of legs.

20. The stand of claim 19, wherein the clamp is configured to couple to a linear portion and to a curved portion of the bridge portion of the pair of legs to thereby inhibit movement of the clamp relative to the pair of legs.
